(19) United States
(12) Patent Application Publication
(10) Pub. No.: US 2007/0171627 A1
(43) Pub. Date: Jul. 26, 2007

(54) Luminous container with magnetic charger

(76) Inventor: Wan-Chang Hsu, Chung-Li (TW)

Correspondence Address: Wan-Chang Hsu, P.O. Box 166-13, Taipei, 114, TW

(21) Appl. No.: 11/336,805

(22) Filed: Jan. 23, 2006

(51) Int. Cl. F21V 33/00

(52) U.S. Cl. 362/101

(57) ABSTRACT

A luminous container with magnetic charger is designed for energizing LEDs to light with induced electromagnetic electricity. Which is free from replacing batteries, when holding the container through a gathering among the guests to talk with amusements. Power supply for lighting 1˜2 hours LEDs is available per charging once on the magnetic charger. Container made of transparent material, which is mostly “hollowed out” between the lining and the casing, a PCB sealed inside the bottom portion thereof; a set of magnetic charger and at least one LED installed thereon. Container is acted by a magnetic field oriented in a specific direction with a field intensity, an induced electromagnetic electricity is conducted by the PCB to light the LED.

### FIELD OF THE INVNETION

The present invention relates to a luminous container with magnetic charger, in particular to an ecological luminous container energized by magnetism.

### GROUND OF THE INVENTION

The conventional luminous container usually is equipped with battery, LEDs, PCB, and switch for lighting. Either a container filled with two liquid agents between the outer and inner wall may mix to cause chemiluminescence, or a container with ring type waveguide to light is disclosed as prior arts. Furthermore, the container is preferrably made of transparent material such as acrylic etc., to emit light from therewith. A dazzling beautiful light can be emitted repeatedly by the LED, which is triggered through a programmed IC on the PCB.

Prior arts such as U.S. Pat. No. 6,889,826 entitled “Luminous container” issued to Shiro Harada et al. on May 10, 2000, in which, Harada taught that two liquid agents are needed to mix to light a container. “A fluorescent material, such as a material including oxalate and dibutyl phthalate, and the other is an oxidizing agent, such as a material including of hydrogen peroxide, catalyst, dimethyl phthalate and t-buthanol. However, the materials are not limited to the above components. A suitable ratio of fluorescent material to oxidizing agent is in the range of 5:1 to 1:1.” is disclosed about the luminous effect. However, EU parliament voted on Jul. 5, 2004 to prohibit the use of three phthalate plasticizers in toys and child care items and to restrict three other plasticizers throughout the EU. Di-n-butyl phthalate (DBP) is one of the three prohibited phthalates, which kinds of phthalates can be continually accepted by the EU, now is concerned by the users. Since in '826, some kinds of phthalates are mentioned, a luminous container by mixing liquid agents to light, may need more efforts to overcome the new challenges posed by such as EU parliament votes.

U.S. Pat. No. 6,193,399 entitled “Optical waveguide structure for vehicle lighting” issued to George R. Hulse on Feb. 27, 2001. In which, George mainly claimed illuminating the interior of a cup holder in a vehicle by a waveguide, which is ring shaped and configured to release light into the cup holder. For example, a bend with a inner bend radius to waveguide width ratio (r/w) of 3:1 will lose less than 5% of the light in the bend. But as the ratio became less and less, the light loss will be increased.

### SUMMARY OF THE INVENTION

Due to the conventional luminous container has some defects such as power consumption easily occurs to a container with battery inside, to replace the battery causes inconvenience to the users.

A switch exposed on the surface of the luminous container further may be touched abruptly in the process of picking it up or putting it down, or occurrence about one luminous container clinks with other containers to activate the power source to emit “courteous light” surely.

For a conventional luminous container, whether the container is activated to light or not, there is no evidence that a lit container filled with beverages, or a dimmed container is symbolized with an empty container, the waiter can see and refill the container with beverages in no time.

Accordingly, the present invention is aimed to provide a luminous container without battery, or a switch exposed outward. Rather, the container can be reflected with the emitting light as the beverages filled within, but a darkened, or dimmed container needs to refill in no time.

Point against aforesaid defects of prior arts, the present invention is to provide a luminous container with magnetic charger, characterized in that: a hollow container made of transparent material; a PCB sealed inside the container; a set of magnetic charger induces a current acted by magnetic field oriented in a specific direction with a field intensity (or magnetic flux density), and at least one LED energized by the induced current.

A luminous container with magnetic charger, wherein the container is composed of a lining and a casing, an elastic member disposed between an underside of the lining and the casing, a piezoelectric switch installed on the PCB is applied to activate a circuitry to light the container by pressing down the lining toward the casing.

A luminous container with magnetic charger, wherein a ring fixed between the top rims of the lining and the casing.

A luminous container with magnetic charger, wherein a water level detecting channel having a floated magnetic ball within is formed in between the lining and the casing, a magnetic switch disposed on a PCB below the channel can cooperate with the magnetic floated ball to construct a circuit.

A luminous container with magnetic charger, wherein a waveguide below the PCB can emit a specific wave to a receiver mounted on the bottom surface of the casing.

A luminous container with magnetic charger, wherein a magnetic coil and a battery disposed on the PCB set up a set of magnetic charger.

Comparison Between the Prior Art and the Present Invention

1. Luminous container is energized by a set of magnetic charger, no need to replace batteries or cells.

2. The switch is designed hidden inside the luminous container, charging 10 minutes can supply sufficient power to light LEDs about 1˜2 hours.

3. By gravity, floating power, and a whole reflection of light rays can sense whether the cup is filled with beverages, further to alternate luminous types of the container (such as intensity of colors and glittering of glowing light can be adjusted in operation), which is admonitory suitably for Table Services. Waiters can see the luminous containers with specific colors to serve the users and refill the required beverages to the containers respectively.

### BRIEF DESCRIPTION OF THE DRAWINGS

FIG. 1: a perspective view of the first embodiment of the luminous container with magnetic charger of the present invention.

FIG. 2: a cross sectional view of FIG. 1.

FIG. 3: a schematic view of the magnetic charging cup holder of the first embodiment.

FIG. 4: an exploded view of the second embodiment of the present invention.

FIG. 5: an assembly view of FIG. 4.

FIG. 6: a cross sectional view of FIG. 4.

FIG. 7: a perspective view of the third embodiment of the present invention.

FIG. 8: a cross sectional view of FIG. 7.

FIG. 9: a cross sectional view of the fourth embodiment of the present invention.

FIG. 10: a schematic view of FIG. 9 in practice.

### DETAILED DESCRIPTION OF THE PREFERRED EMBODIMENTS

### First Embodiment

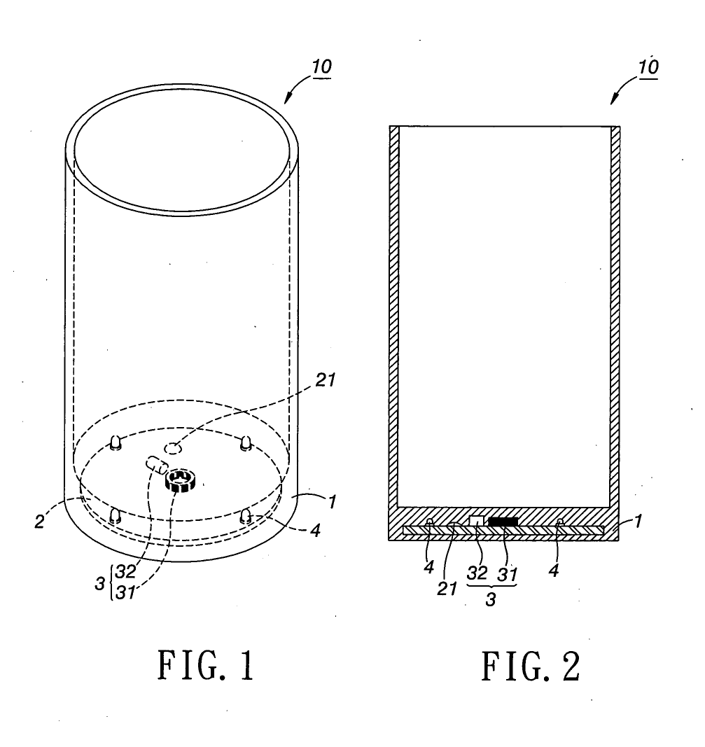

As shown in FIGS. 1 and 2, the luminous container (10) includes a cup body (1) made of pervious to light materials, a PCB (2) is embedded in the cup body (1), which is shielded by the cup body (1) without direct contact with other objects. A set of magnetic charger (3), IC (21), and at least one LED (4) are disposed on the PCB (2). The magnetic charger (3) consists of magnetic coil (31) and batteries (32). A magnetic field oriented in a specific direction having a field intensity (or magnetic flux density) acts on the cup body (1), a magnetic coil (31) mounted inside the magnetic charger (3) induces sufficient electricity to the LED (4), LED (4) emits light to mix the ambient light.

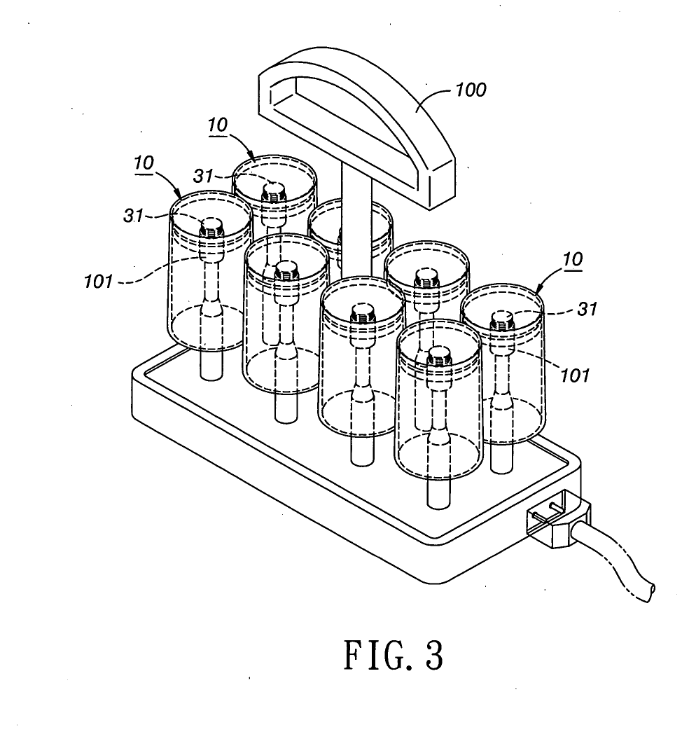

As shown in FIG. 3, the container (10) is energized by a charging cup holder (100), or cup coaster (cup buoy), or other devices can set charging coil (101) within itself. Such charging coil (101) is corresponding to the magnetic coil (31) of the container (10) to produce a magnetic field, the magnetic coil (31) of the container (10) induces electricity for charging to the batteries (32). After charging, the batteries (32) are full of power. No matter the container (10) is occupied on the charging cup holder (100) or being kept a distance from the charging cup holder (100), the LEDs (4) illuminate red light.

### Second Embodiment

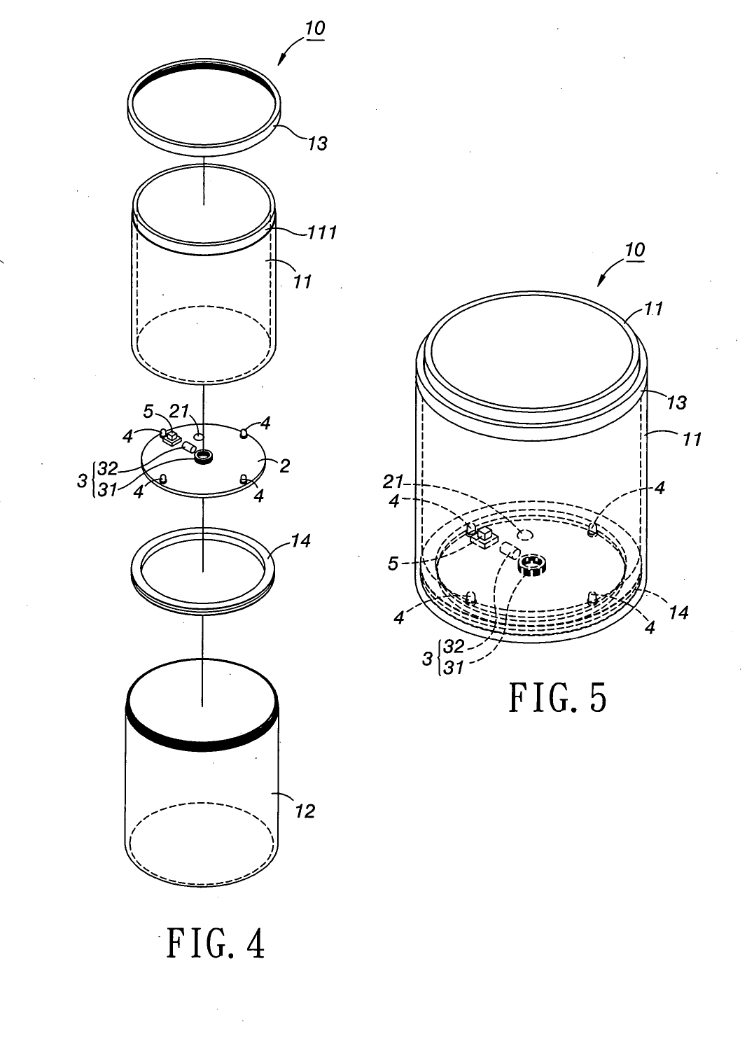

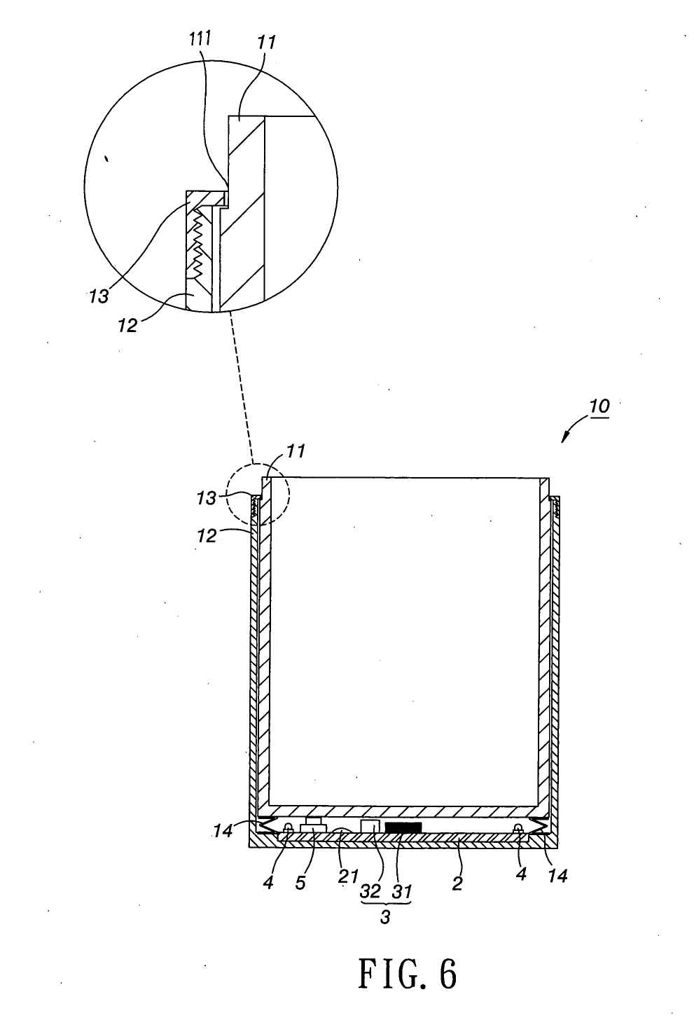

As shown in FIG. 4, the container (10) includes a lining (11), a casing (12) for receiving the lining (11), a ring (13) fit between the upper rims of the lining and casing, an elastomer (14) disposed below the underside of the lining (11), a PCB (2) disposed in the bottom surface of the casing (12) with a set of magnetic charger (3), LEDs (4) and pressure sensitive switch (5) mounted on the PCB (2). After combination, an assembly view and a cross section view are illustrated as shown in FIGS. 5 and 6.

The hollowed lining (11) is made of material pervious to light, on the top rim of the lining is formed as a step ring (111), the hollowed casing (12) is also made of material pervious to light, because the inner diameter of the casing (12) is greater than the outer diameter of the lining (11); therefore, the lining (11) can slide into the cavity of the casing (12), the ring (13) is fixed to the top rim of the casing (12) by screwing or welding etc., the ring (13) is relative to the step ring (111) to prevent the lining (11) from tearing apart or clinking with the casing (12). The elastomer (14) is disposed around between the bottom rims of the lining (11) and the casing (12). When the lining (11) and the casing (12) are coupled with each other to form as a whole, both of the lining (11) and the casing (12) are combined as a whole to compress the elastomer (14) sandwiched in between. For example, the lining (11) filled with liquid, its weight is increased to descend and depress the sandwiched elastomer (14), the relative height of the lining (11) is lowered, a set of magnetic charger (3), which is the same as the set of magnetic charger (3) described in the first embodiment, and at least an LED (4) is installed on the PCB (2). A piezoelectric switch (5) is disposed on the PCB (2). When depressing, the piezoelectric switch can alternate the circuit to an open mode or a closed mode. While the lining (11) is filled with water to exert a pressure to the sandwiched elastomer (14), which is depressed to shrink, accompanied by the filled water lining (11) continually sunk down to trigger the piezoelectric switch (5), at this time, the open or closed modes of the circuit can be alternated by the piezoelectric switch (5).

### Third Embodiment

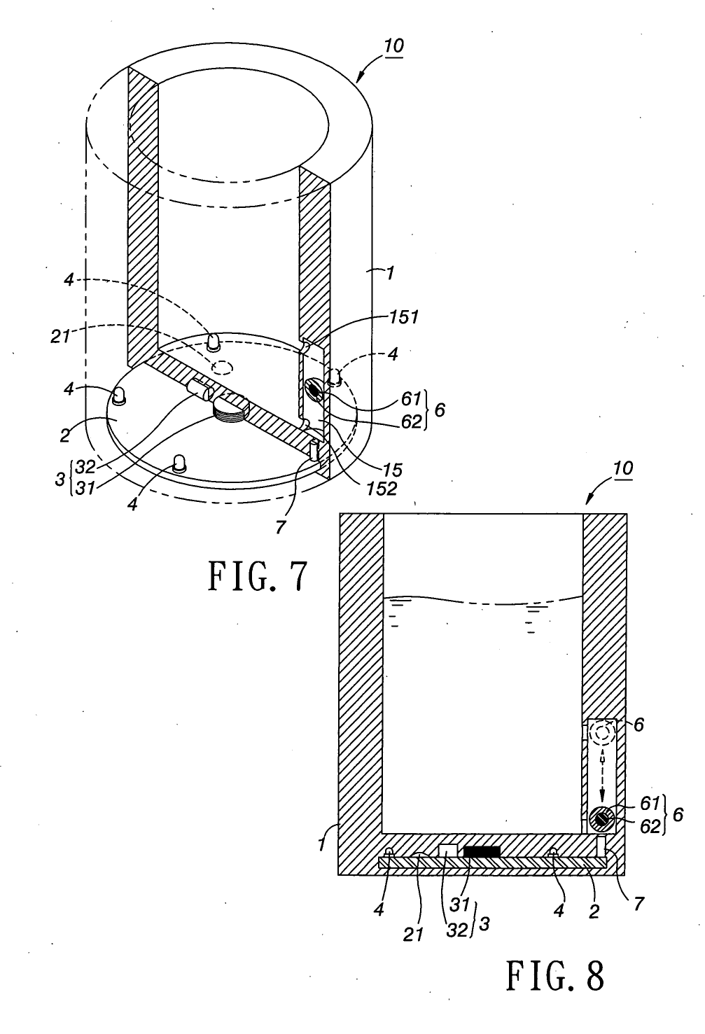

As shown in FIGS. 7 and 8, the luminous container (10) includes a hollowed cup (1), which is made of material pervious to light, a water level detecting channel (15) is formed between the lining (11) and the casing (12), the channel is “hollowed out” in between and in communication within the lining and the casing of the container, an upper water guide hole (151) and a lower water guide hole (152) formed on the lining, a step height is kept between the upper and lower guide hole for adjusting the water flow in or out in balance. A PCB (2) is embedded into the bottom portion of the container (10), which is substantially sealed between the bottoms of the lining and the casing that is insulated from the external application. A magnetic charger (3) and at least one LED (4) are installed on the PCB (2), when they are acted by a magnetic field oriented in a specific direction with a field intensity (or magnetic flux density), the magnetic charger can induce electricity. PCB (2) conducts power to the LEDs (4) sufficiently to activate the LEDs (4) to light. A magnet (61) enclosed by a plastic (62) to form a floated magnetic ball (6), the ball is disposed within the water level detecting channel (15), the ball fluctuated up or down depends on a rise or fall of the water surface being filled in or drained out. A magnetic switch (7) disposed on the PCB (2), which is positioned right below the channel (15); as the water level in the container is higher, the magnetic floated ball (6) is kept away from the magnetic switch (7). On the other hand, the water level in the cup is lower, or water drained out to empty the container, the magnetic floated ball (6) is approached to the magnetic switch (7) to activate the magnetic switch (7) to alternate the open or closed modes of the circuit.

### Fourth Embodiment

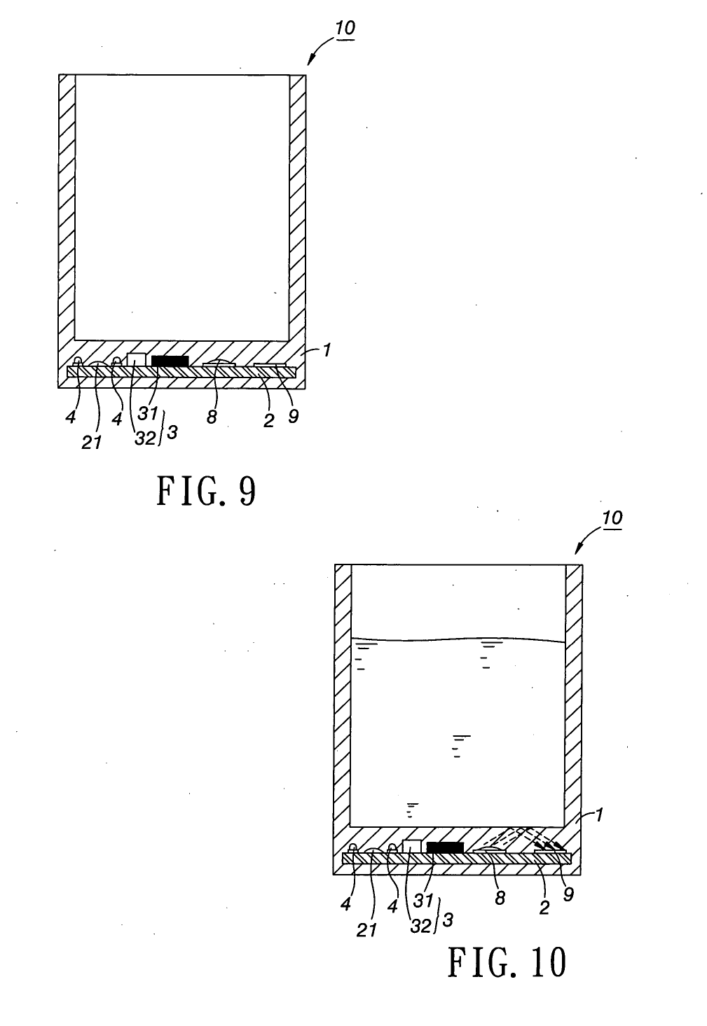

As shown in FIGS. 9 and 10, the luminous container (10) includes a hollowed cup made of material pervious to light, a PCB (2) embedded inside the cup (1) and insulated from the external applications, a magnetic charger (3) and at least a LED (4) are installed to the PCB (2), a waveguide (8) disposed on the PCB (2) emits specific wave length light rays to the underside of the lining (1) and the emitted light rays should be reflected back to the bottom surface of the casing, a receiver (9) disposed on the PCB (2) faces the underside of the lining to receive the guided light rays emitted from the waveguide (8). When the cup (1) was empty with no water filled within, (as shown in FIG. 9) the guided light rays emitted by the waveguide (8) is deflected out the cup (1), which is not retained or reflected by the water level, the deflected out light rays is hardly reached the receiver (9) disposed to the bottom surface of the casing so that the receiver (9) can not be activated. But the cup (1) is filled with water to the brim thereof (as shown in FIG. 10), the guided light emitted by the waveguide (8) is in a whole reflection phenomenon according to the density of the water and the cup which is varied from each other. Most reflected light rays can be received by the receiver (9) directly or indirectly. Therefore, the receiver (9) can alternate and switch the open mode or closed mode of the circuit.

What is claim claimed:

1. A luminous container with magnetic charger characterized in that: a hollow container made of transparent material; a PCB sealed inside the container; a set of magnetic charger induces a current acted by magnetic field oriented in a specific direction with a magnetic field intensity, and at least one LED energized by the induced current.

2. A luminous container with magnetic charger according to claim 1, wherein the container is composed of a lining and a casing, an elastic member disposed between an underside of the lining and the casing, a piezoelectric switch installed on the PCB is applied to activate a circuitry to light the container by pressing down the lining toward the casing.

3. A luminous container with magnetic charger according to claim 1, wherein a ring fixed between the top rims of the lining and the casing.

4. A luminous container with magnetic charger according to claim 1, wherein a water level detecting channel having a floated magnetic ball within is formed in between the lining and the casing, a magnetic switch disposed on a PCB below the channel can cooperate with the magnetic floated ball to construct a circuit.

5. A luminous container with magnetic charger according to claim 1, wherein a waveguide below the PCB can emit a specific wave length light to a receiver mounted on the bottom surface of the casing.

6. A luminous container with magnetic charger according to claim 1, wherein a magnetic coil and a battery disposed on the PCB set up a set of magnetic charger.
